(19) United States
(12) Patent Application Publication
(10) Pub. No.: US 2026/0048967 A1
(43) Pub. Date: Feb. 19, 2026

(54) MULTIPLE BRAKE HOIST FOR OVERHEAD CRANE

(71) Applicant: Mazzella Lifting Texhnologies, Inc., Cleveland, OH (US)

(72) Inventor: Larry J. Costa, Winston Salem, NC (US)

(73) Assignee: Mazzella Lifting Texhnologies, Inc., Cleveland, OH (US)

(21) Appl. No.: 18/807,941

(22) Filed: Aug. 17, 2024

(51) Int. Cl. B66D 5/30; B66C 17/00; B66D 3/22

(52) U.S. Cl. CPC B66D 5/30; B66D 3/22; B66C 17/00

(57) ABSTRACT

A multiple brake hoist system includes a hoist for lifting and lowering a load and a power supply for supplying electrical power to the hoist. The power supply is configured to retain electromagnetic and capacitive energy upon deactivation. Primary and secondary brakes engage the hoist upon deactivation from the power supply. The primary and secondary brakes are connected to the power supply in a fail-safe configuration to maintain a non-engaged state on the hoist during activation of the power supply. The primary brake establishes an engaged state on the hoist upon deactivation from the power supply. The secondary brake establishes an engaged state on the hoist after a predetermined time-delay associated with consuming the predetermined amount of electromagnetic and capacitive energy of the power supply upon deactivation. In this manner, the primary and secondary brakes prevent a differential torsional stress between the mechanical components upon deactivation of the power supply.

### I. BACKGROUND

### A. Technical Field

This invention pertains to the field of overhead cranes used in industrial environments such as factories. An overhead crane typically includes two elevated parallel rails for supporting a traveling bridge capable of moving back and forth along the rails. A hoist is mounted on the bridge for raising and supporting a load, which is moved along the rails, for transporting materials within the industrial environment.

### B. Description of Related Art

During a hoisting operation using an overhead crane, it can happen that an additional load is added to the existing load of the hoist while the hoist is holding its position. Such an additional load might exceed the capacity of the hoist and thereby cause the drum of the hoist to move, thus causing a fault in the hoist drive, which could result in the hoisted load being dropped.

To mitigate this problem, it is known in the art to provide multiple braking devices to the hoist, including a primary brake and one or more secondary brakes. A time delay is performed between applying the primary and secondary brakes in order to reduce torsional stress between the mechanical components of the hoist, including one or more gearboxes, couplings, frames, mounts, etc., located between the brakes. Such torsional stress can cause these components to excessively wear or unexpectantly fail, which can result in dropping the hoisted load. The interval of the time-delay is specific for each different model of hoist, based on the masses and load bearing capabilities of each of the aforementioned mechanical components that compose the specific hoist model.

Existing prior art time-delay braking devices include external components such as a speed controlling hydraulic or friction device used to control the time it takes for secondary mechanical brakes to be applied during normal, emergency stop and power failure operations of a hoist. However, the actual time-delay of the system is a variable influenced by mechanical wear, along with ambient and operational temperatures of the aforementioned components. Therefore, the actual resulting time-delay for applying the secondary brake can vary widely for each hoist model, resulting in inconsistent operation, raising safety concerns.

Ongoing monitoring and maintenance of the hoist system is required to ensure that a specific hoist model is operating with the specific time-delay required for that model. The existing types of speed controlling hydraulic or friction devices entails initial setup by a skilled technician, and further includes regular maintenance and frequent operational testing to ensure safety of the system. This is a labor-intensive and thus expensive process.

### II. SUMMARY

Provided in this disclosure is a multiple brake hoist system including a hoist for lifting and lowering a load and a power supply for supplying electrical power to the hoist brakes. The power supply is configured to retain a predetermined amount of electromagnetic and capacitive energy upon deactivation. A primary brake is provided for engaging the hoist upon deactivation from the power supply. The primary brake is connected to the power supply in a fail-safe configuration to maintain a non-engaged state on the hoist during activation of the power supply, and to establish an engaged state on the hoist upon deactivation from the power supply. A secondary brake is provided for engaging the hoist upon deactivation from the power supply. The secondary brake is connected to the power supply in a fail-safe configuration to maintain a non-engaged state on the hoist during activation of the power supply, and to establish an engaged state on the hoist after a predetermined time-delay associated with consuming the predetermined amount of electromagnetic and capacitive energy of the power supply upon deactivation.

In one aspect, the hoist also includes a drive motor for powering the hoist and a gearbox for lifting and lowering the load. The primary brake is configured to engage either the drive motor or the gearbox, while the secondary brake is configured to engage either the drive motor or the gearbox. The primary brake and secondary brake each include a biasing spring and a corresponding electrical coil. These springs respectively establish the engaged state upon deactivation, while the power supply cooperates with the coils to respectively maintain the biasing springs in the non-engaged state during activation. A secondary brake control relay feeds the electrical power from the power supply to the secondary brake to maintain its non-engaged state for the predetermined time-delay. The predetermined time-delay is in a range between 1 and 3 seconds.

The present invention provides a multiple brake hoist having a primary brake and one or more secondary brakes. It will be appreciated that the primary and secondary brakes are “fail-safe” in that power is supplied to the brakes to maintain them in an open, non-engaged state on the hoist during activation of the power supply. The primary and secondary brakes each include a spring/coil component including biasing spring which is biased to engage the hoist, where each spring cooperates with an electrical coil to exert an outward force on the spring to hold the spring in an open non-engagement position. Thus, in the event power is deactivated, either intentionally or due to a power failure, the brakes will engage the hoist.

The present multiple brake hoist provides simplified circuit design, components, and operation that supplies and maintains power to the secondary electrical brake coil for a consistent period of time after deactivation of the power supply, thereby delaying engagement of the secondary brake. The present invention maintains power to the secondary brake by utilizing the electromagnetic energy present in the power supply (i.e., electrical energy associated with inductance and capacitance) without requiring an external power supply such as batteries for energy storage or any sort of mechanical timing delay components. The present invention operates during normal hoist operation, and also for emergency stops, along with any power failure operations, due to electrical or mechanical failure.

This is accomplished by selecting specific power supply components associated with the mass and load bearing capabilities of each different model of hoist. It is contemplated that the invention utilizes a correctly sized and selected commercially available products, approved by Underwriters Laboratory (UL), and any other suitable regulators. Such approved power supplies include internal electromagnetic and capacitive energy storage components used in conjunction with its standard current and voltage sensing and control circuits. Such components are initially electrically powered up to provide the initial electrical voltage and current surge for activating the electrical coils in the spring/coil component of each brake. The electrical coils apply force to the biasing springs within each spring/coil component to release the brake to thereby permit movement of the hoist. When power is turned off the internal electromagnetic and capacitive energy of the power supply supplies and maintains the voltage and electrical current to the electrical coils of the secondary brake for a consistent time to reliably delay, for a specific amount of time, engagement of the secondary brake to secure the hoist.

Additional embodiments for this invention could include Individual Hoist Brake Testing electrical control circuitry, components, and functionality of the existing types of a speed controlling hydraulic or friction braking devices.

Other benefits and advantages of this invention will become apparent to those skilled in the art to which it pertains upon reading and understanding of the following detailed specification.

### III. BRIEF DESCRIPTION OF THE DRAWINGS

The disclosed multiple brake hoist may take physical form in certain parts and arrangement of parts, embodiments of which will be described in detail in this specification and illustrated in the accompanying drawings which form a part hereof and wherein:

FIGS. 1A, 1B, and 1C are respective top, front, and side views of a multiple brake hoist in accordance with a first exemplary embodiment of the present invention.

FIGS. 1-1 and 1-2 are respective power and control electrical schematics depicting activation and release of the primary and secondary brakes of the multiple brake hoist.

FIGS. 2A, 2B, and 2C are respective top, front, and side views of a multiple brake hoist.

FIGS. 2-1 and 2-2 are respective power and control electrical schematics depicting activation and release of the primary and secondary brakes of the multiple brake hoist.

FIGS. 2-3A, 2-3B, and 2-3C depict operative positions of a brake testing operator selector switch for testing.

FIGS. 3A, 3B, and 3C are respective top, front, and side views of a multiple brake hoist.

FIGS. 3-1 and 3-2 are respective power and control electrical schematics depicting activation and release of the primary and secondary brakes of the multiple brake hoist.

FIGS. 3-3A, 3-3B, and 3-3C depict operative positions of a brake testing operator selector switch for testing.

FIGS. 4A, 4B, 4C, and 4D are respective top, front, side, and back views of a multiple brake hoist.

FIGS. 4-1 and 4-2 are respective power and control electrical schematics depicting activation and release of the primary and secondary brakes of the multiple brake hoist.

### IV. DETAILED DESCRIPTION

Reference is now made to the drawings wherein the showings are for purposes of illustrating embodiments of the article only and not for purposes of limiting the same, and wherein like reference numerals are understood to refer to like components.

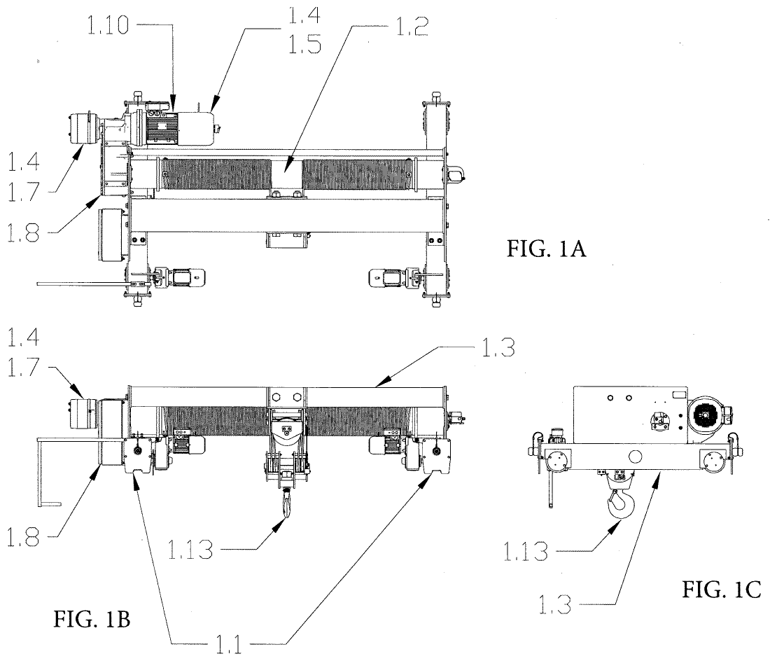

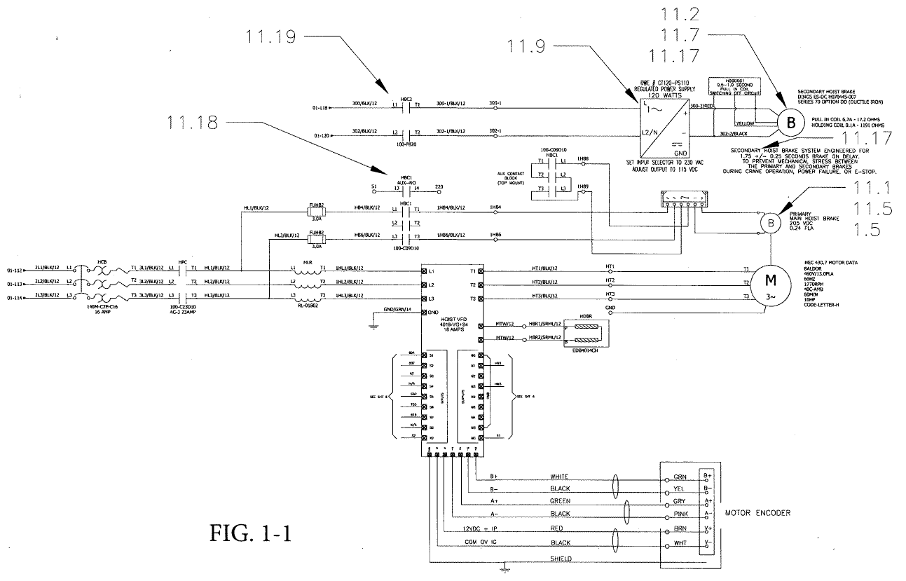

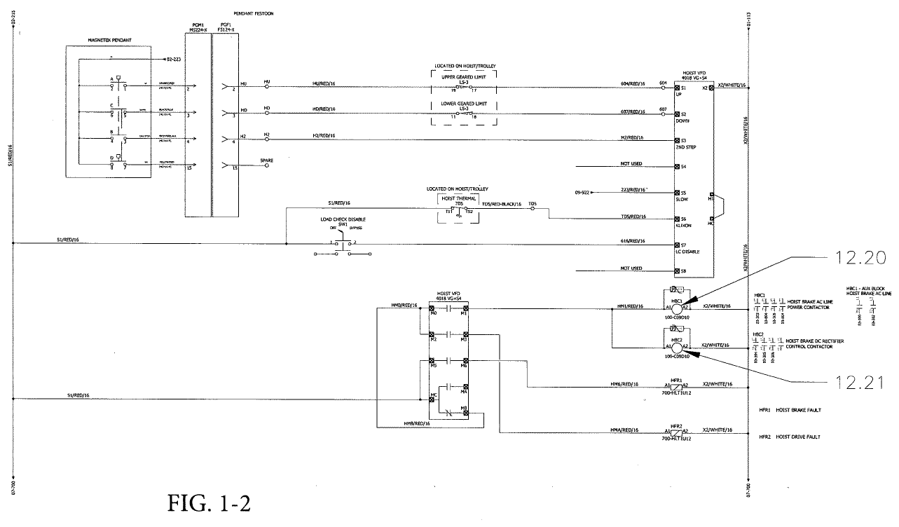

FIGS. 1A, 1B, and 1C depict a top running double girder 1.1 for supporting a hoist 1.3 (i.e., hoist trolley) having a drum 1.2 around which a cable is wound for lifting and lowering a load. A primary brake 1.4 is integrally mounted on the end of a drive motor 1.10. It is to be understood that the drive motor 1.10 receives electrical power from an external power supply (discussed hereinbelow). The primary brake 1.4 as shown includes a spring/coil component to enable fail-safe operation as described in detail hereinabove. The primary brake 1.4 is “fast acting” in that it engages the drive motor 1.10 immediately upon deactivation of the power supply. The primary brake 1.4 is electromechanically released upon reactivation of the motor. A secondary brake 1.7 electrically operating similar to the primary brake 1.4 is integrally mounted on the opposite side of a drive reduction gearbox 1.8 of the hoist 1.3 for lifting the load using a hook 1.13 connected to the cable wrapped around the drum 1.2.

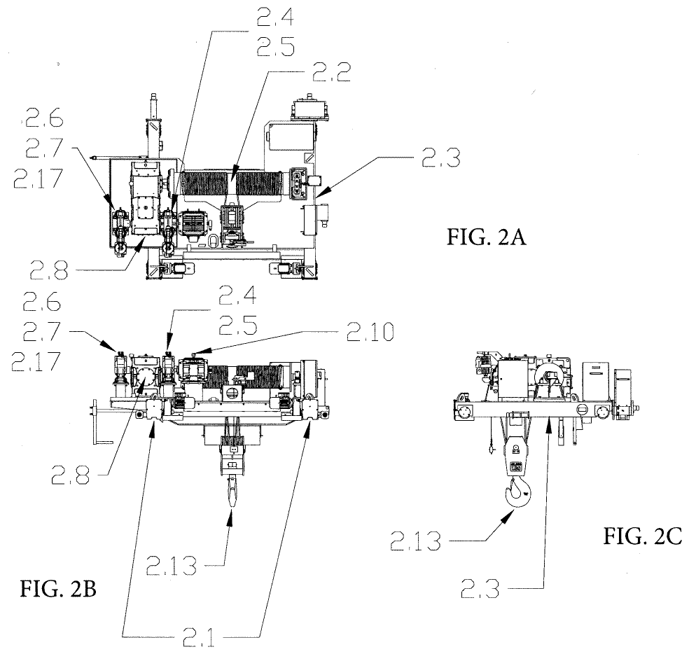

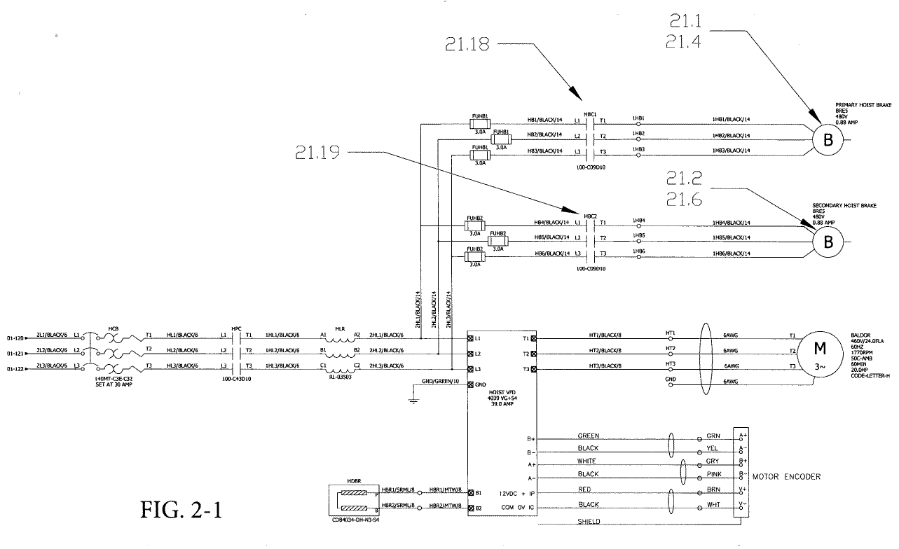

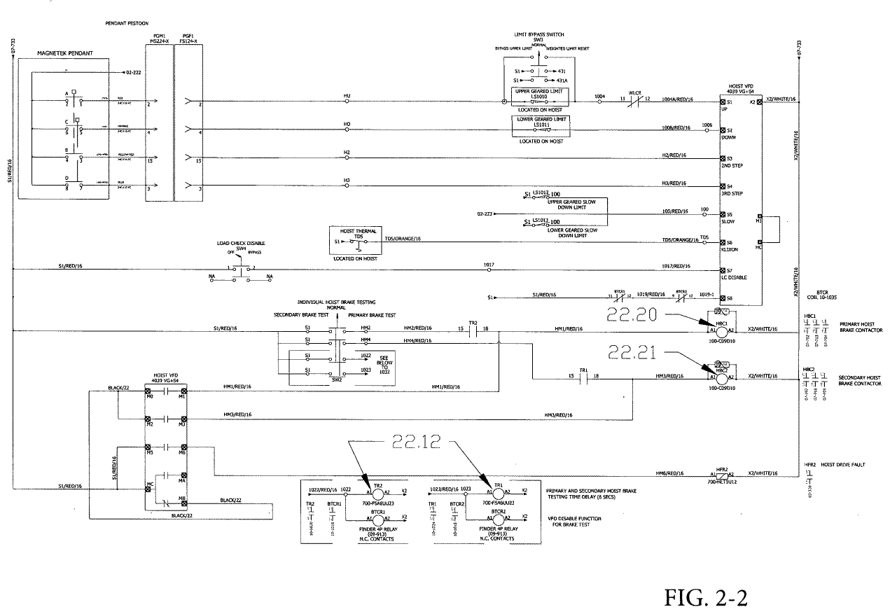

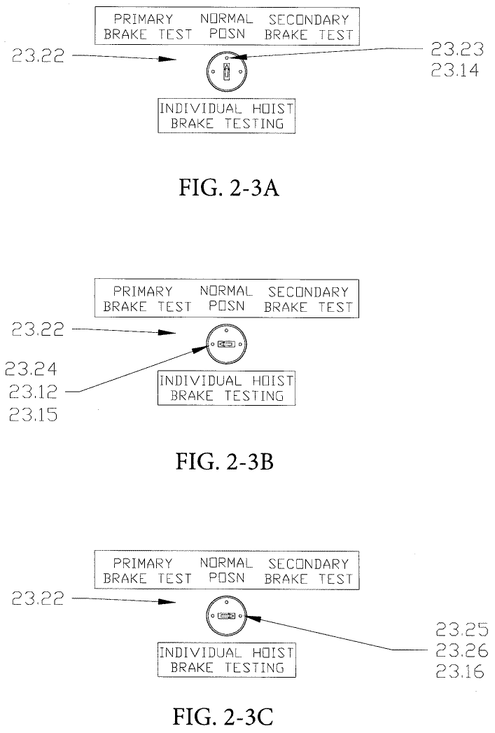

FIG. 1-1 is a power electrical schematic of the hoist 1.3. Individual electrical power feeding control contactors are provided. The primary brake 11.1 and the secondary brake 11.2 are activated and released using respective individual control relay contactors 11.18, 11.19 that are simultaneously activated using their respective electrical coils 12.20, 12.21 as also shown in FIG. 1-2. The control relay contactor 11.18 of the primary brake 11.15 has a power feed connected to an activation/release coil circuit 12.20 of the primary brake 11.15 thereby causing the primary brake coil 11.5 to immediately deactivate upon deactivation of the power supply. This causes the primary hoist brake 1.5 to engage while the coil 12.21 of the contactor 11.19 or the secondary brake control relay 11.16 feeds AC power to an AC to DC voltage power supply 11.9. The AC to DC voltage power supply 11.9 then quickly provides the DC activation/release power to the secondary brake 1.7 and thereby maintains power for 1 to 3 seconds after the power supply is shut off. In this manner, the engagement of the secondary brake 1.7 has a time-delay of 1 to 3 seconds after the power feed contactor opens.

FIG. 1-2 is a control electrical schematic of the hoist having a simplified control circuit that simultaneously controls the activation and de-activation of the electrical contactor 11.15 of the primary brake and the electrical contactor 11.16 of the secondary brake as shown in FIG. 1-1 via their respective relay coils 12.20, 12.21.

FIGS. 2A, 2B, and 2C depict a top running double girder 2.1 for supporting a hoist 2.3 (i.e., hoist trolly) having a drum 2.2 around which a cable us wound for lifting and lowering a load. A primary brake 2.5 (similar in fail-safe construction and operation to that discussed in the previous embodiment hereinabove) and can include a fast acting speed controlling hydraulic or friction devices to minimize the time it takes for the Primary mechanical brake to be applied. The primary brake 2.5 is separately mounted between the drive motor 2.10 and the input of a drive reduction gearbox 2.8 of the hoist. A slower acting secondary brake 2.7 (similar in fail-safe construction and operation to that discussed in the previous embodiment hereinabove) and can include a slower acting speed controlling hydraulic or friction device to delay the time for the secondary brake 2.7 to be applied to a time delay of 1 to 3 seconds 2.17. The secondary brake 2.7 is separately mounted on the opposite side of the drive reduction gearbox 2.8 for lifting the load using a hook 2.13 connected to the cable wrapped around the drum 2.2.

FIG. 2-1 is a power electrical schematic of the hoist 2.3 Individual electrical power feeding control contactors are provided. The primary brake 21.1 and the secondary brake 21.2 are activated and released using their respective individual control relay contactors 21.18, 21.19 using their respective electrical coils 22.20, 22.21 as also shown in FIG. 2-2. The power feed of the brake control contactors is independently connected to the fast acting primary brake activation/release coil circuit 21.4 and the slower acting secondary brake.

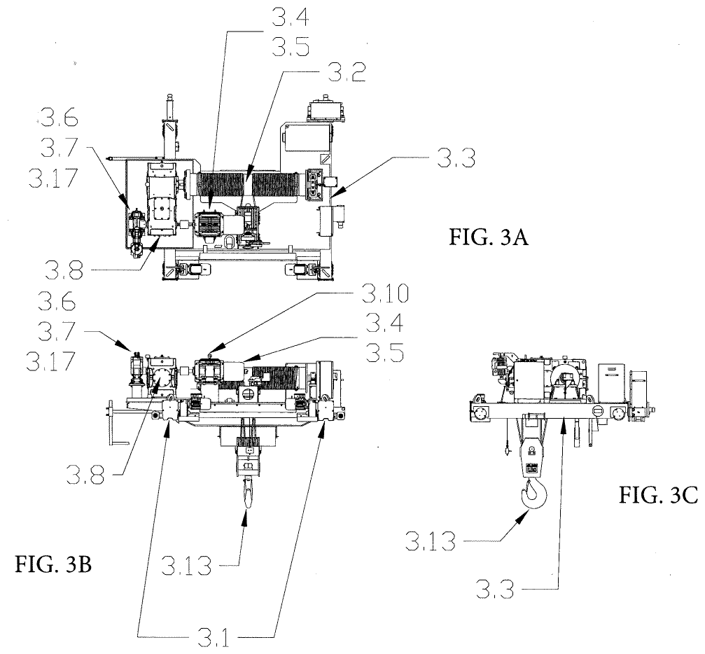

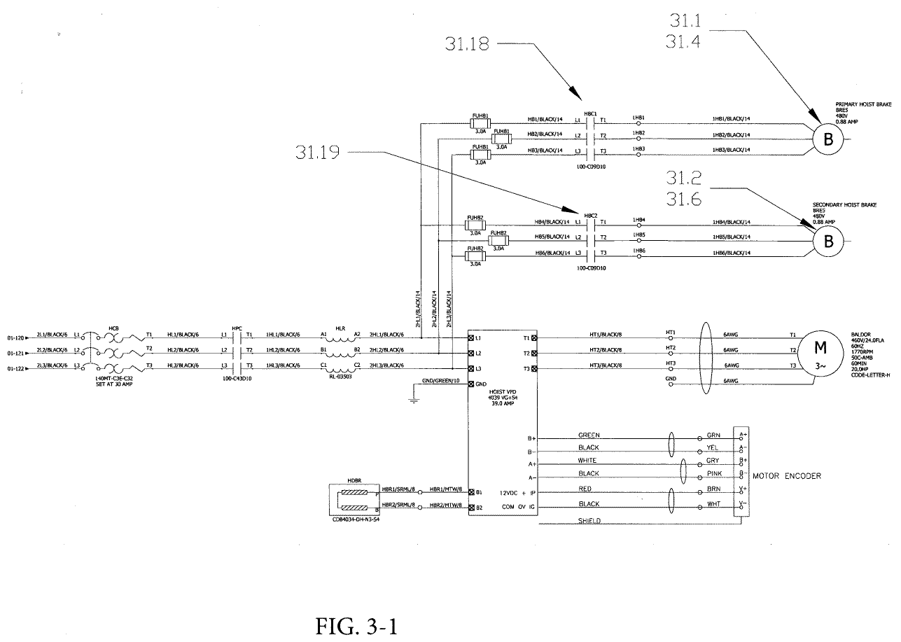

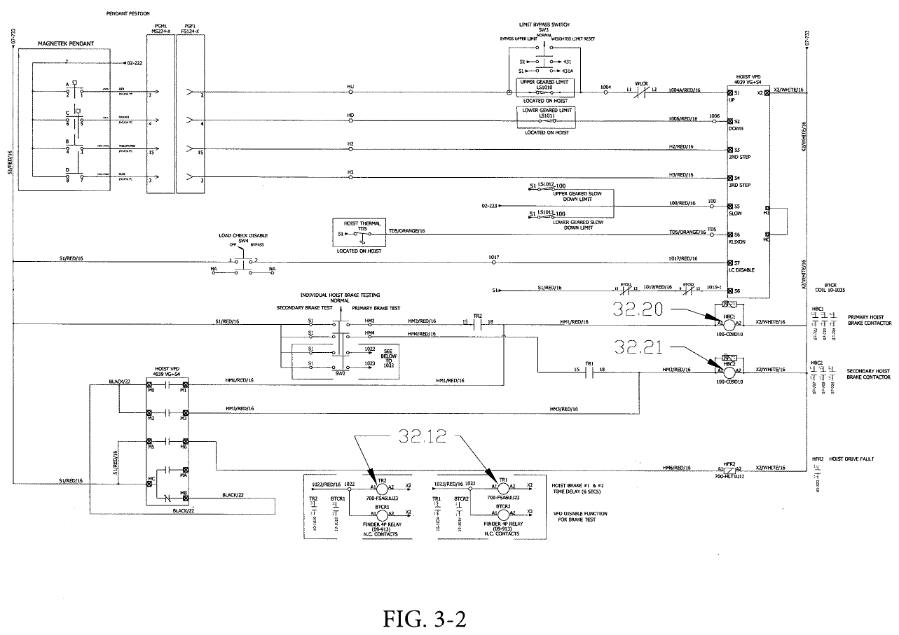

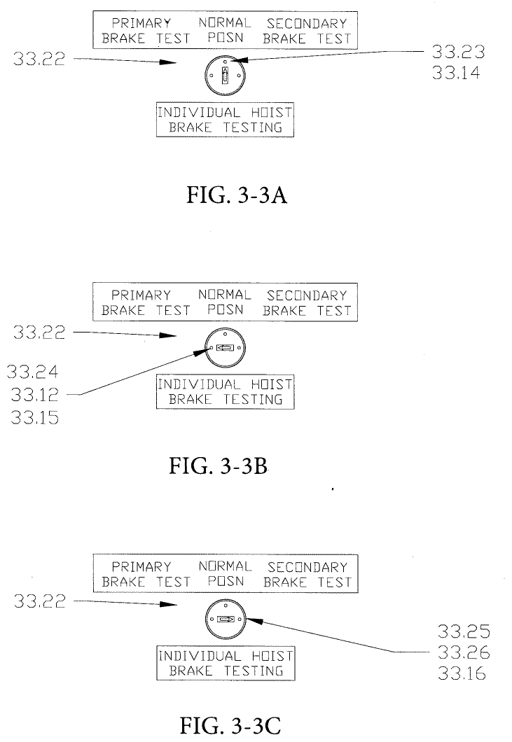

FIG. 2-2 is the control electrical schematic of the hoist having an individual primary brake testing circuit 21.4 and also a secondary brake testing circuit 21.5. These testing circuits 21.4, 21.5 are selectable (see FIG. 2-3) using respective individual control relays 21.18, 21.19 and contactor coils 22.20, 22.21 to facilitate isolated testing of either the fast acting primary brake 2.4 or the slower acting secondary brake 2.6. This testing delays the activation and release of a selected brake a time delay 22.12 of 6 seconds to reduce the risk of non-application of the non-selected brake to reduce the risk for dropping the load.

FIGS. 2-3A, 2-3B, and 2-3C depict three operative positions of an individual brake testing operator selector switch 23.22. FIG. 2-3A shows the normal operation 23.14 for activating either the primary brake testing circuit 23.15 or the secondary brake testing circuit 23.15. The components in FIG. 2-2 are tested separately for either the primary brake 2.5 or the secondary brake 2.6 by delaying activation of the selected brake to reduce the risk of the non-selected brake not being applied to reduce the risk for dropping the load.

FIG. 2-3A depicts the individual brake testing operator selector switch 23.22 in its center position 23.23 indicating normal brake operation 23.14. FIG. 2-3B depicts the individual brake testing operator selector switch 23.22 in its left position 23.24 for testing the primary hoist brake 2.5 by releasing the secondary hoist brake 2.6 after a 6 second time delay 23.12 for the ensuring engagement of the primary hoist brake 23.5. FIG. 2-3C depicts the individual brake testing operator selector switch 23.22 in its right position 23.25 for testing the secondary hoist brake 2.6 by releasing the primary hoist brake 2.5 after a time delay of 6 seconds for ensuring engagement of the secondary hoist brake 2.6.

FIGS. 3A, 3B, and 3C depict a top running double girder 3.1 for supporting a hoist 3.3 (i.e., hoist trolley) having a drum 3.2 around which a cable is wound for lifting and lowering a load. A primary brake 3.5 cooperates with a fast acting speed controlling hydraulic or friction device to minimize the time it takes for the primary mechanical brake 3.5 to be applied. The primary brake 3.5 is integrally mounted on the end of the drive motor 3.10. The slower acting secondary brake 3.7 is applied with a slower acting speed controlling hydraulic or friction device to delay the time for the secondary mechanical brake 3.7 to be applied, resulting in a time-delay 3.17 of 1 to 3 seconds. The secondary brake 3.7 is separately mounted on the opposite side of the drive reduction gearbox 3.8 used for lifting the load using a hook 3.13 connected to the cable wrapped around the drum 3.2.

FIG. 3-1 is a power electrical schematic of the hoist 3.3. Individual electrical power feeding control contactors are provided. The primary brake and the secondary brake are activated and released using respective individual control relay contactors 31.18, 31.19 that are activated using respective electrical coils 32.20, 32.21 as also shown in FIG. 3-2. The power feed of the control relay contactors 31.18, 31.19 is independently connected to the activation/release coil circuits of the fast acting primary brake 31.4 and the slower acting secondary brake 31.6.

FIG. 3-2 is a control electrical schematic of an individual hoist (31.4) primary brake testing circuit 31.4 and a secondary brake testing circuit 31.5. These circuits 31.4, 31.5 are selectable (as shown in FIGS. 3-3A, 3-3B, and 3-3C) using the contactor coils 32.20, 32.21 of their respective individual control relays 31.18, 31.19 to facilitate isolated testing of either the fast acting primary 3.4 or the slower acting secondary brake 3.6. This results in a time-delay 22.12 of the activation and release of the selected brake for 6 seconds to reduce the risk that the other non-selected brake would not be applied, to thereby reduce the risk for dropping the load.

FIGS. 3-3A, 3-3B, and 3-3C depict three operative positions of an individual brake testing operator selector switch 33.22. FIG. 3-3A shows the normal operation 33.14 for activating either the primary brake testing circuit 33.15 or the secondary brake testing circuit 33.16. The components in FIG. 3-2 are tested separately for either the primary brake 3.5 of the secondary brake 3.7 by delaying activation of the selected brake to reduce the risk of the non-selected brake not being applied and dropping the load.

FIG. 3-3A depicts the individual brake testing operator selector switch 33.22 in its center position 33.23 indicating normal brake operation 33.14. FIG. 3-3B depicts the individual brake testing operator selector switch 33.22 in its left position 33.24 for testing the primary brake 3.5 by releasing the secondary brake 3.6 after a time delate 33.12 of 6 seconds for the ensuring engagement of the primary brake 3.5. FIG. 3-3C depicts the individual brake testing operator selector switch 33.22 in its right position 33.25 for testing the secondary brake 3.6 by releasing the primary brake 3.5 after a time delay 33.26 of 6 seconds for ensuring engagement of the secondary brake 3.6.

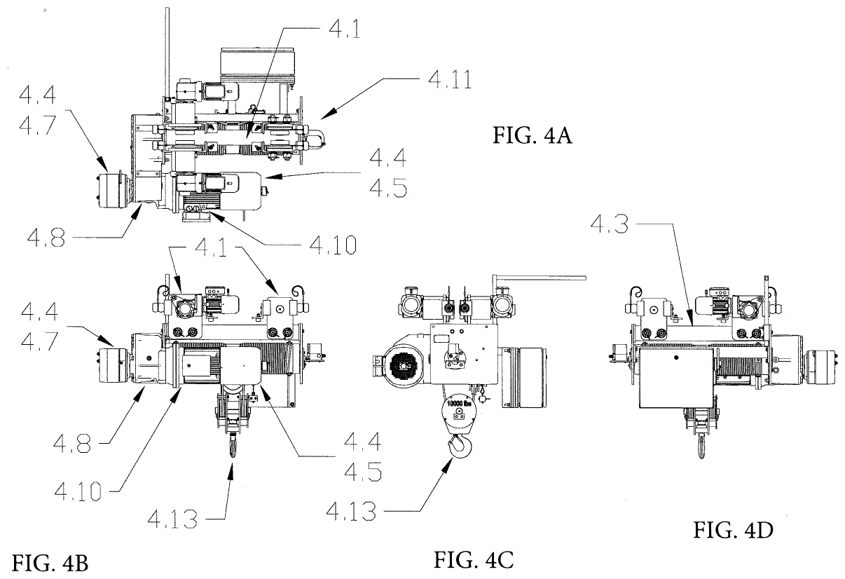

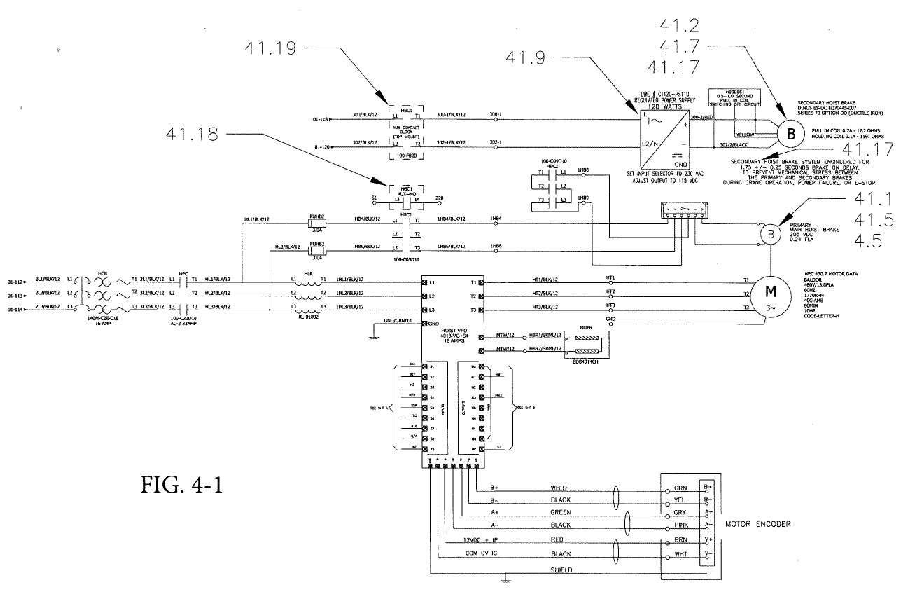

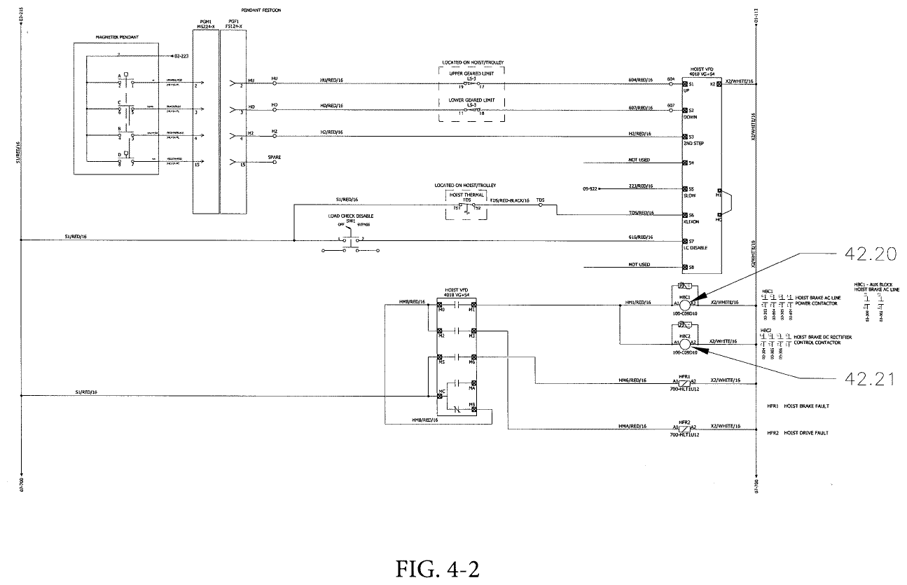

FIGS. 4A, 4B, 4C, and 4D depict a bottom running single girder 4.1 with a hoist trolley 4.3 having a fast acting primary brake 4.5 integrally mounted on the end of the drive motor 4.10 with a secondary brake 4.7 integrally mounted on the opposite side of the drive reduction gearbox 4.8 for lifting the load using a hook 4.13 in accordance with the description hereinabove.

FIG. 4-1 is a power electrical schematic of the hoist 4.3. Individual electrical power feeding control contactors are provided. The primary brake 41.1 and the secondary brake 41.2 are activated and released using respective individual control relay contactors 41.18, 41.19 that are simultaneously activated using respective electrical coils 42.20, 42.21 as also shown in FIG. 4-2. The control relay 41.15 of the primary brake includes a contactor 41.18 having a power feed connected to the associated coil circuit 42.20. This causes the primary brake 4.5 to immediately deactivate and engage. Meanwhile the coil 42.21 of the control relay 41.16 of the contactor 41.19 of the secondary brake feeds AC power to an AC to DC voltage power supply 41.9 that quickly provides the DC power for the activation/release of the brake. This maintains the activation/release power of the secondary brake for a time delay 41.17 of 1 to 3 seconds after the power supply is shut off.

FIG. 4-2 is a control electrical schematic of the hoist 4.3 depicting a simplified control circuit that simultaneously controls the activation and de-activation of the electrical control contactors 41.15, 41.16 respectively associated with the primary and secondary brakes shown FIG. 4-1 using their respective relay coils 42.20, 42.21.

Based on the foregoing description, it will be appreciated that one having skill in the art could select suitable components in order to arrive at a workable solution. For example, the embodiment depicted ibn FIG. 1-1 could be implemented using as a drive motor a Baldor 460V/13.0FLA motor as sold by ABB Motors and Mechanical Inc. of Fort Smith, AR. This embodiment could also be implemented using as a secondary brake a DINGS ES-DC H070445-007 Series 70 Option DD brake sold by Dings Dynamics Group of Milwaukee, WI. This embodiment could also be implemented using as a power supply a DWE CT120-PS110 power supply sold by De Wit Elektronika of the Netherlands. Other suitable components from these or any other manufacturers could also be selected to arrive at a workable solution without departing from the present invention.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A multiple brake hoist system, comprising:
a hoist for lifting and lowering a load;
a power supply for supplying electrical power to the hoist, wherein the power supply is configured to retain a predetermined amount of electromagnetic and capacitive energy upon deactivation;
a primary brake for engaging the hoist upon deactivation from the power supply, wherein the primary brake is connected to the power supply in a fail-safe configuration to maintain a non-engaged state on the hoist during activation of the power supply, and to establish an engaged state on the hoist upon deactivation from the power supply; and
a secondary brake for engaging the hoist upon deactivation from the power supply, wherein the secondary brake is connected to the power supply in a fail-safe configuration to maintain a non-engaged state on the hoist during activation of the power supply, and to establish an engaged state on the hoist after a predetermined time-delay associated with consuming the predetermined amount of electromagnetic and capacitive energy of the power supply upon deactivation.

2. The multiple brake hoist system of claim 1, wherein the hoist further comprises a drive motor for powering the hoist and a gearbox for lifting and lowering the load.

3. The multiple brake hoist system of claim 2, wherein the primary brake is configured to engage one of the drive motor or the gearbox, and wherein the secondary brake is configured to engage one of the drive motor or the gearbox.

4. The multiple brake hoist system of claim 1, wherein the primary brake and secondary brake each comprise a biasing spring and a corresponding coil, wherein the springs respectively establish the engaged state upon deactivation, wherein the power supply cooperates with the coils to respectively maintain the biasing springs in the non-engaged state during activation.

5. The multiple brake hoist system of claim 1, further comprising a secondary brake control relay for feeding the electrical power from the power supply to the secondary brake to maintain power for the predetermined time-delay.

6. The multiple brake hoist system of claim 1, wherein the predetermined time-delay is in a range between 1 and 3 seconds.
